(19) United States
(12) Patent Application Publication
(10) Pub. No.: US 2008/0027950 A1
(43) Pub. Date: Jan. 31, 2008

(54) METHOD OF DISTRIBUTING DISK IMAGE IN COMPUTER SYSTEM

(75) Inventor: Koichi FUKUMI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/781,681

(22) Filed: Jul. 23, 2007

(30) Foreign Application Priority Data
Jul. 27, 2006 (JP) 2006-204424

(51) Int. Cl. G06F 17/30

(52) U.S. Cl. 707/10; 707/E17.032

(57) ABSTRACT

A disk image distributing method includes copying a first image containing a program necessary to start a computer, as a part of a disk image to a storage unit of a predetermined computer; starting the predetermined computer based on the program; and copying a second image as a remaining part of the disk image into the storage unit of the predetermined computer after the start of the predetermined computer. The predetermined computer may be a spare computer to be added to a current operation system, and the disk image is of a computer in the current operation system.

### TECHNICAL FIELD

The present invention relates to a computer system. Particularly, the present invention relates to a technique to distribute a disk image to a computer which is newly added to an operation system in the computer system.

### BACKGROUND ART

A server system is known which provides various kinds of services via a network. The server system is composed of a plurality of servers. If a load is increased due to the increase in the number of users, a new server is added to an operation system so as to increase a processing capability, as described in Japanese Laid Open Patent Application (JP-P2006-11860A)

The server system is provided with a group of spare servers in advance in order to prepare for a request to add a server. When the server is added, it is considered to select one server from among the group of spare servers and install a necessary OS and software in a selected spare server. However, since an installation process requires a prolonged time, a disk image of a distribution server is generally distributed to a selected spare server.

FIG. 1 is a flowchart showing a method of adding a server in a related art. First, a disk image of a server in the operation state is prepared in advance (step S101). The disk image includes an OS, a middleware, and applications, and is referred to as a “distribution source image” hereinafter. Then, when an additional server allocation is requested (step S102), a management server selects an arbitrary spare server from among a group of registered spare servers (step S103). The management server copies a distribution source image to a disk of the selected spare server (step S104). When a copy is completed, a process of starting the spare server is performed (step S105). An additional server thus starts a task.

The present inventor focused attention on following points. A period of time from requesting an additional server allocation (step S102) to starting a task in an additional server (step S105) is substantially determined based on a period of time for copying a distribution source image. Particularly, when a size of a distribution source image is large, starting a task in an additional server is significantly delayed. From a viewpoint of a service provider, it is desirable to start a task in an additional server as early as possible.

### SUMMARY

An exemplary object of the present invention is to provide a computer system in which a period of time before starting a task in an additional computer can be shortened when a new computer is added to an operation system.

In an exemplary aspect of the present invention, a disk image distributing method includes copying a first image containing a program necessary to start a computer, as a part of a disk image to a storage unit of a predetermined computer; starting the predetermined computer based on the program; and copying a second image as a remaining part of the disk image into the storage unit of the predetermined computer after the start of the predetermined computer.

The predetermined computer may be a spare computer to be added to a current operation system, and the disk image is of a computer in the current operation system.

In another exemplary aspect of the present invention, a computer system includes a management computer; and a computer connected with the management computer through a network. The management computer copies a first image which is a part of a predetermined disk image and which contains a program necessary to start the computer into a storage unit of the computer, and the computer copies a second image which is a remaining part of the predetermined disk image into the storage unit, after being started based on the program.

In still another exemplary aspect of the present invention, a computer system includes a copy determining module configured to determine whether an entity of a target data as an access target exists when a storage unit is accessed; and a copying module configured to control a copy of the target data from a specified copy source to the storage unit when a substance of the target data does not exist.

In still another exemplary aspect of the present invention, a management computer includes an image distributing module configured to copy a first image which is a part of a predetermined disk image into a computer connected through a network. The first image contains a program necessary to start the computer and a module configured to control a copy of a second image which is a remaining part of the predetermined disk image.

According to the present invention, the first image containing the program necessary to start at least is first copied. Immediately after, the computer is started based on the program. Thus, the computer to be added can start a task. The second image is copied during the execution of the task. In this way, it is possible to shorten a time from issuance of an allocation request to the start of the task by the computer to be added.

### BRIEF DESCRIPTION OF DRAWINGS

The above and other objects, advantages and features of the present invention will be more apparent from the following description of exemplary embodiments taken in conjunction with the accompanying drawings, in which:

FIG. 1 is a flowchart showing a method to distribute a distribution source image according to a conventional technique;

FIG. 2A is a block diagram showing an example of a schematic configuration of a server system according to an exemplary embodiment of the present invention;

FIG. 2B is a block diagram showing another example of the schematic configuration of the server system according to the exemplary embodiment of the present invention;

FIG. 3 is a flowchart showing a method to distribute a distribution source image according to the exemplary embodiment of the present invention;

FIG. 4 is a diagram to explain an effect of the present invention;

FIG. 5 is a conceptual diagram showing a distribution source image according to a first exemplary embodiment of the present invention;

FIG. 6 is a conceptual diagram showing an example of a file system;

FIG. 7 is a conceptual diagram showing an example of an i-node;

FIG. 8 is a conceptual diagram showing another example of the file system;

FIG. 9 is a block diagram showing a configuration according to the first exemplary embodiment;

FIG. 10A is a flowchart showing a method to copy a second image in the first exemplary embodiment;

FIG. 10B is a flowchart showing a method to copy the second image in the first exemplary embodiment;

FIG. 11 is a conceptual diagram showing another example of the i-node:

FIG. 12 is a conceptual diagram showing the distribution source image according to a second exemplary embodiment of the present invention;

FIG. 13 is a block diagram showing a configuration according to the second exemplary embodiment;

FIG. 14 is a conceptual diagram showing a copy list in the second exemplary embodiment;

FIG, 15A is a flowchart showing a method to copy the second image in the second exemplary embodiment;

FIG. 15B is a flowchart showing a method to copy the second image in the second exemplary embodiment;

FIG. 16 is a diagram to explain a third exemplary embodiment of the present invention;

FIG. 17 is a block diagram showing a configuration according to the third exemplary embodiment;

FIG. 18 is a conceptual diagram showing image distribution data in the third exemplary embodiment;

FIG. 19 is a conceptual diagram showing a copy source list in the third exemplary embodiment; and

FIG. 20 is a conceptual diagram showing the copy source list in the third exemplary embodiment.

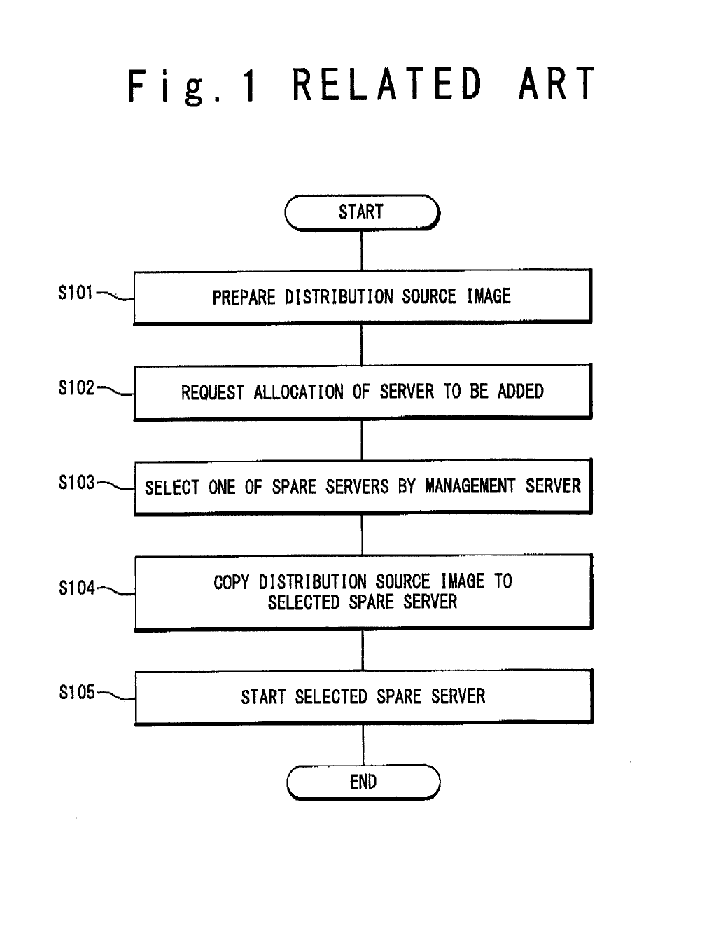

### EXEMPLARY EMBODIMENTS

Hereinafter, a computer system according to exemplary embodiments of the present invention will be described with reference to the attached drawings. The computer system includes an autonomous computer system, a utility computer system, a grid system, and a virtual computer system. A server system which provides various kinds of services is exemplified as the computer system in the present embodiment.

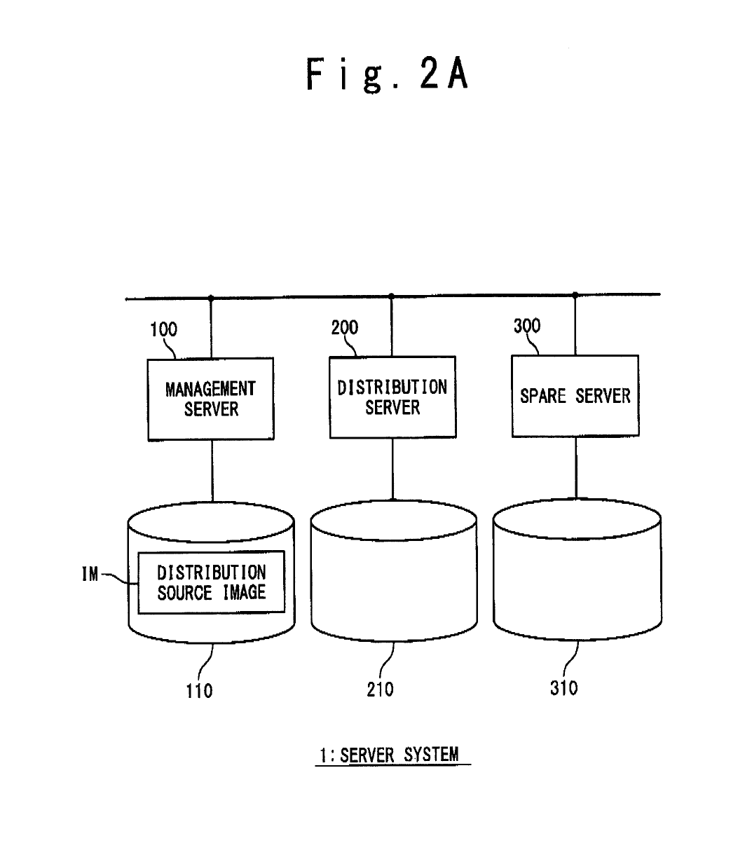

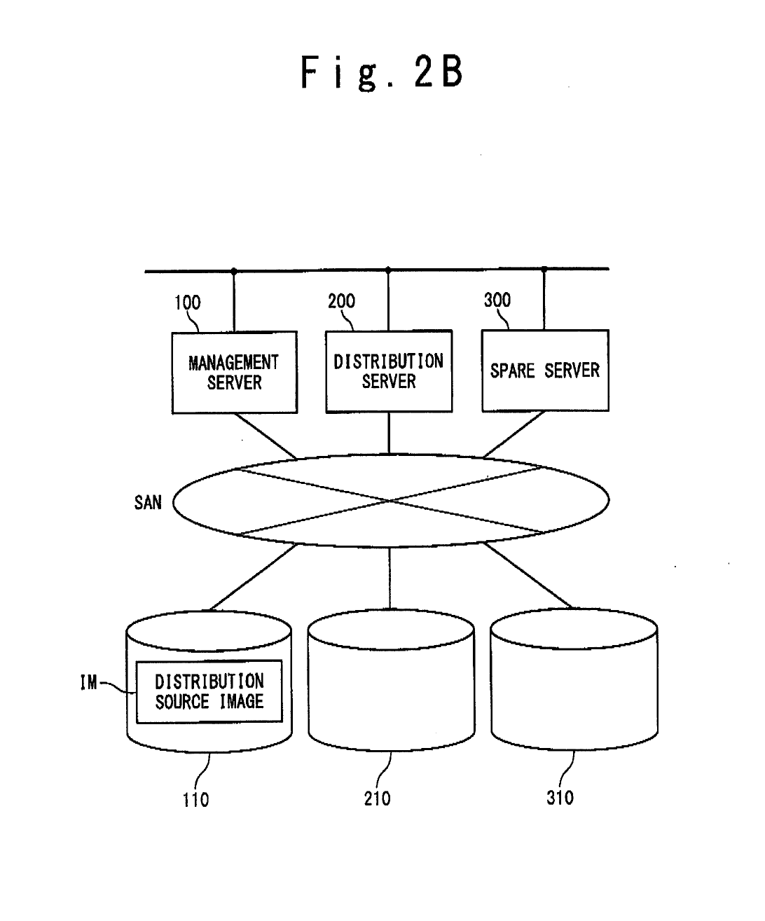

First, an outline of the present invention will be described. FIG. 2A shows an example of a conceptual configuration of a server system 1 according to the present embodiment. The server system 1 is provided with a group of servers to be connected to each other via a network such as a LAN. The group of servers includes a management server 100, a distribution server 200, and a spare server 300. The management server 100 is a server to manage the entire servers. The distribution server 200 is a server in an operation state. The spare server 300 is a server which is incorporated into an operation system as needed.

The server system 1 is also provided with a group of storages 110, 210, and 310 that are used by the servers. The storage 110 (master disk) is a storage used by the management server 100. The storage 210 is a storage used by the distribution server 200. The storage 310 is a storage used by the spare server 300. The management server 100 is accessible to the entire storages 110, 210, and 310.

When the spare server is incorporated into the operation system, a “distribution source image IM” of the distribution server 200 in the operation state currently is distributed to the spare server 300. The distribution source image IM is a disk image of the distribution server 200, including an operating system (OS), a middleware, and applications. The distribution source image IM is stored in the storage 110 in advance.

A configuration of the sever system 1 is not limited to the configuration shown in FIG. 2A. For example, the group of servers 100 to 300 may be connected to the group of storages 110 to 310 by an SAN (storage area network). Alternatively, the server system 1 may support the iSCSI. In case of the iSCSI, the group of storages 110 to 310 is directly connected to a network to be shared by a plurality of servers.

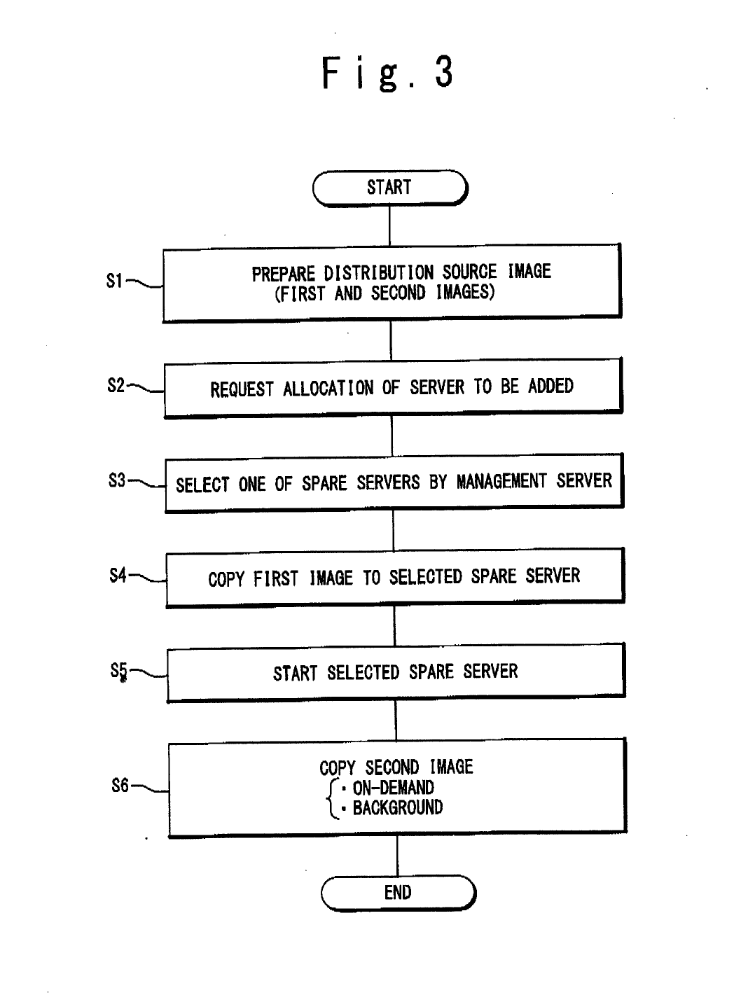

FIG. 3 is a flowchart showing a process of adding a server according to the present invention. First, the management server 100 prepares the distribution source image IM of the distribution server 200 in the operation state (step S1). The distribution source image IM can be separated into a “first image IM1” and a “second image IM2”. The first image IM1 is a part of the distribution source image IM, including at least a program required to start the server. The second image IM2 is a remaining part of the distribution source image IM. The distribution source image IM to be prepared is stored in a predetermined storage. The distribution source image IM may be stored collectively and may be stored distributedly.

Thereafter, a user or load monitoring software requests the management server 100 to allocate an additional server (step S2). In response to the request, the management server 100 selects one spare server 300 from a group of registered spare servers (step S3). The management server 100 can select the spare server 300 which is suitable for the distribution source image IM by comparing a hardware configuration between the distribution server 200 and each of the spare servers of the group.

Next, the management server 100 exclusively copies the first image IM1 to the storage 310 of the selected spare server 300 (step S4). As described above, the first image IM1 includes a program required to start the server. Under this state, the management server 100 starts the spare server 300 by utilizing a WOL (wake-on LAN) function (step S5). The management server 100 also executes a necessary process such as setting a network/storage. At this time, the spare server 300, i.e. an additional server starts a task.

Subsequently, the second image IM2 is copied to the storage 310 in the task executed by the additional server (step S6). For example, the second image IM2 is copied by an on-demand system in response to a request from the additional server (spare server 300). The second image IM2 may also be copied in a background of operation in the additional server. When it is completed to copy the second image IM2 entirely, a process of distributing the distribution source image IM is ended.

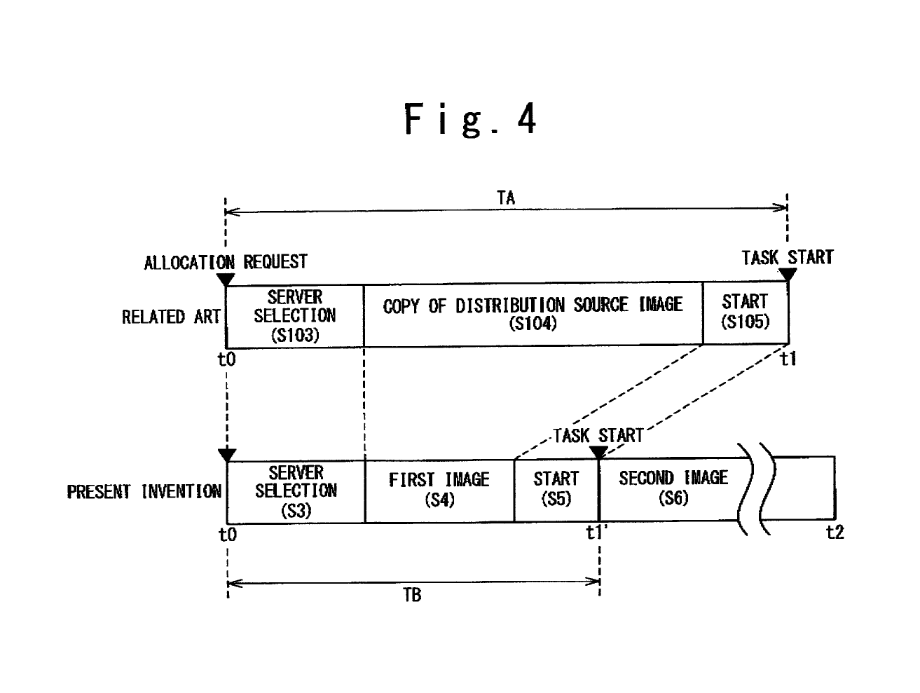

FIG. 4 shows a comparison between a related art and the present invention. According to the related art, after an allocation request at time to, a server selection (step S103), a copy of the entire distribution source image (step S104), and a start (step S105) are performed in this order. The additional server starts a task at time t1. Meanwhile, according to the present invention, immediately after copying the first image IM1, which is a part of the distribution source image IM (step S4), a start process is performed (step S5). Accordingly, time t1′ at which the additional server starts a task is earlier than time t1. That is, a period of time from the allocation request to the start of a task in the additional server is shortened from TA to TB.

With respect to the remaining second image IM2, an on-demand copy or a background copy is performed after starting the additional server and during a task executed by the additional server. The copy of the second image IM2 is completed at time t2. Although a period of time to copy the entire distribution image IM is extended, a period of time spent before starting a task in the additional server is shortened. This is preferable from a viewpoint of continuity of providing a service.

The distribution of the distribution source image according to the present invention will be described in detail. In particular, details of a method of copying the second image IM2 will be described.

### First Exemplary Embodiment

### Classification of Distribution Source Image

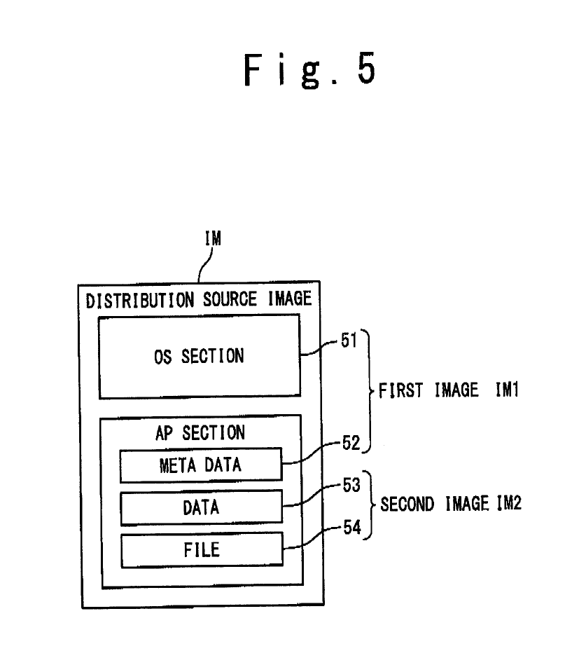

FIG. 5 is a conceptual diagram showing classification of the distribution source image IM in a first exemplary embodiment of the present invention. The distribution source image IM includes an OS unit 51 and an AP (application) section. The OS section 51 is equivalent to a boot image, being a minimum program required to start the server. The AP section includes meta data 52, data 53, and files 54. The meta data 52 is data to manage the file, including directory data, for example. In the first exemplary embodiment, the first image IM1 includes the OS section 51 and the meta data 52. The second image IM2 includes the data 53 and the entity files 54 as an image other than the first image IM1.

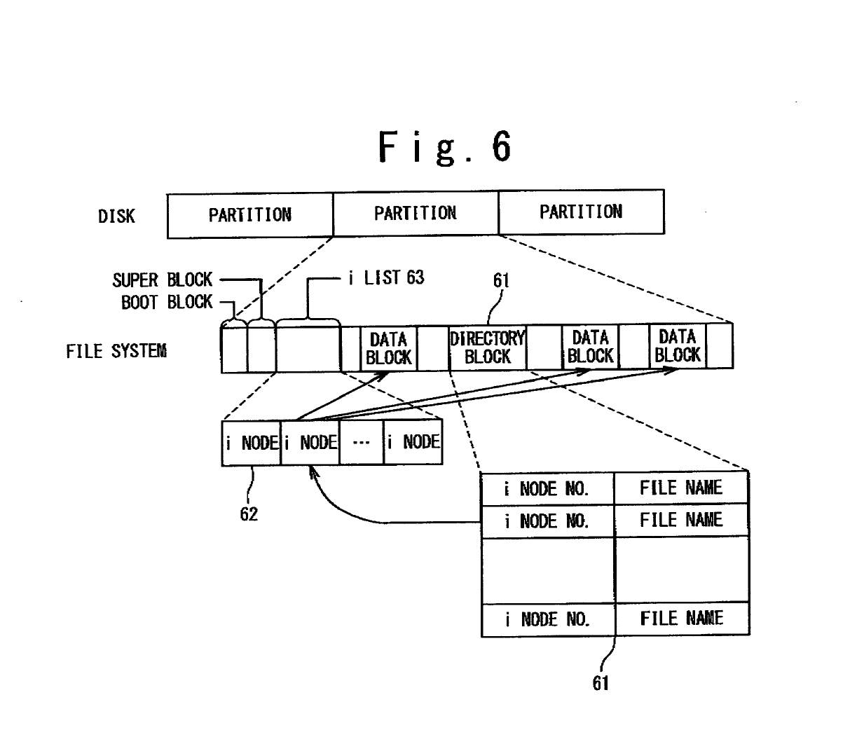

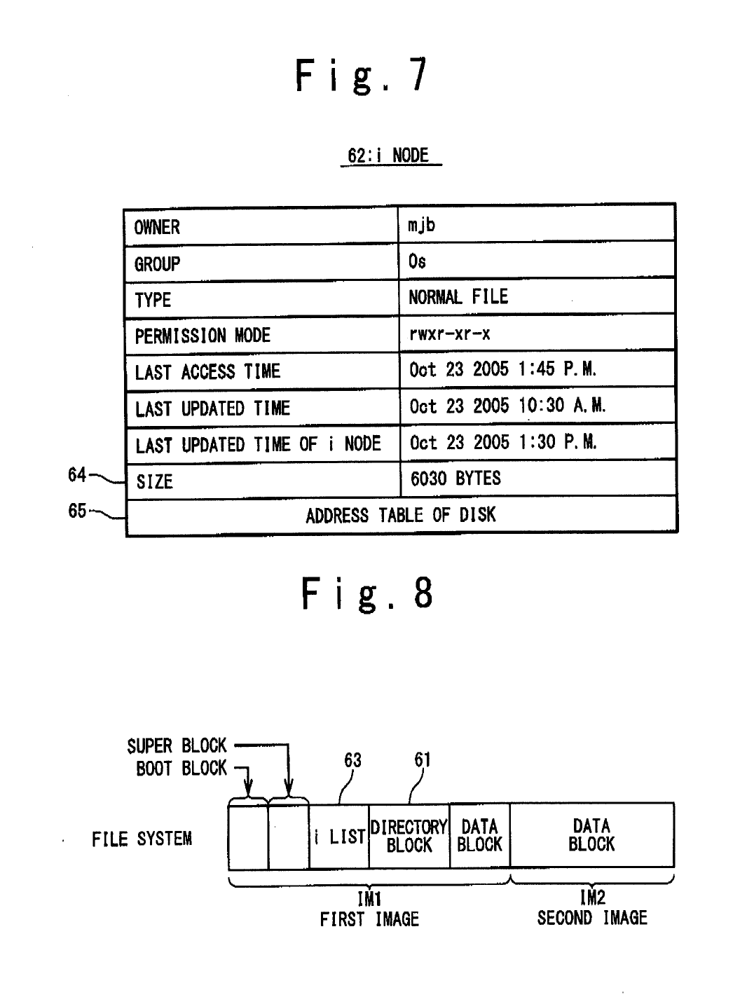

The meta data 52 will be described by using a detailed example. FIG. 6 is a diagram showing a conceptual file management system in a generally known UNIX (registered trademark) system. A disk region is divided into a plurality of partitions. A file system in each of the partitions includes a boot block, a super block, an i-list 63, a data block, and a directory block 61. The boot block is a region in which a program (boot strap code) used at the time of starting the server is stored. The i-list 63 is composed of a group of i-nodes 62. The i-node (index-node) 62 is data related to a certain file, and provided separately from an entity of the file. FIG. 7 shows an example of the i-node 62. The i-node 62 has a size 64 of the file and an address table 65 which indicates a location of an entity of the file, in addition to a type of the file and a permission mode. All the files are managed by the i-nodes 62.

The directory block 61 is also a kind of a file. As shown in FIG. 6, the directory block 61 indicates names of the files included in the directory and numbers of the i-nodes 62 corresponding to the files. When a certain file is referred to, the i-node 62 corresponding to the file is determined from the directory block 61. A location of an entity of the file on a disk is determined from the i-node 62. It is thus made possible to access a specified file.

In an example shown in FIG. 6, the directory block 61 and the i-list 63 are equivalent to the meta data 52, which is data to manage the file. That is, the directory clock 61 and the i-list 63 are included in the first image IM1. Therefore, it is preferable that a boot block, a super block, the i-list 63, and the directory block 61 are continuously disposed on a disk as shown in FIG. 8. In this way, it becomes easier to distinguish the first image IM1 from the second image IM2. A data block in which an entity of the file except for the OS section 51 exists is not included in the first image IM1, but included in the second image IM2.

The files on the disk 210 of the distribution server 200 may be managed in a format as shown in FIG. 8 from the beginning. In this case, the first image IM1 and the second image IM2 can be easily prepared. Meanwhile, when the disk 210 of the distribution server 200 is managed in a format shown in FIG. 6, file locations are replaced in preparing the first image IM1 and the second image IM2. Due to the replacement, the first image IM1 and the second image IM2 can be prepared in the format as shown in FIG. 8.

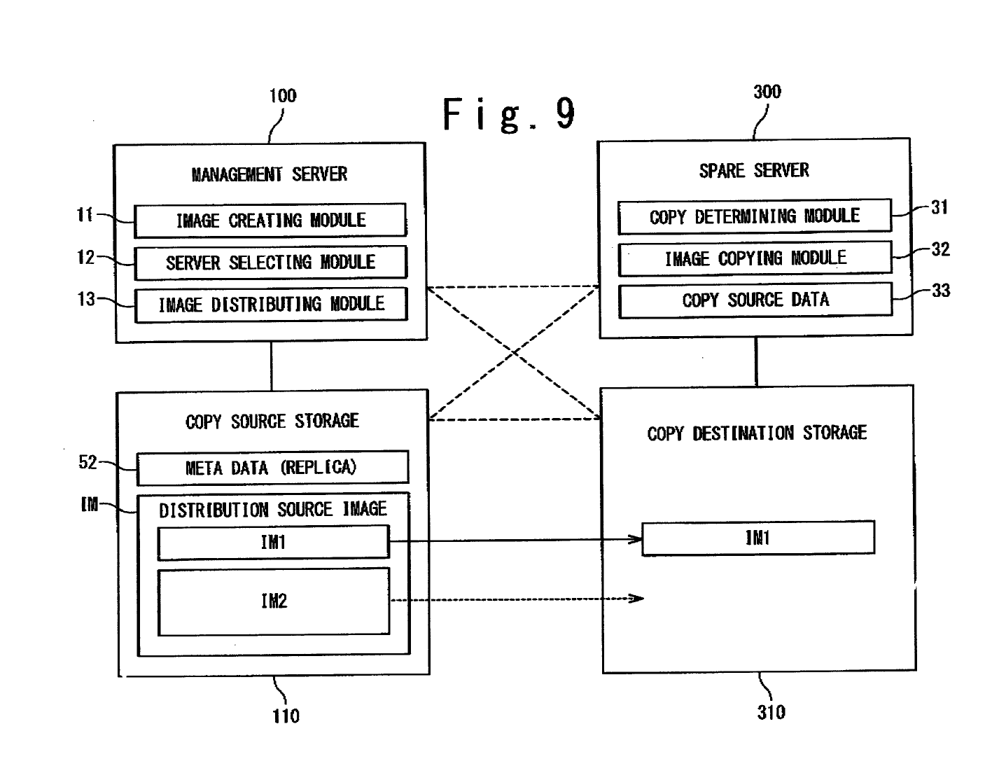

FIG. 9 shows a configuration of the server system 1 according to the first exemplary embodiment. In FIG. 9, the management server 100, the spare server 300, a copy source storage 110, and a copy destination storage 310 are extracted and shown in particular. Although the storage 110 used by the management server 100 is exemplified as the copy source storage 110, there is no limitation to the storage. The copy source storage 110 may be any storage as long as it is accessible by the management server 100. The copy destination storage 310 is a storage used by the spare server 300. The copy source storage 110 stores the distribution source image IM which is an object to be distributed. The distribution source image IM is composed of the fist image IM1 and the second image IM2.

The management server 100 has an image creating module 11, a server selecting module 12, and an image distributing module 13. The image creating module 11 creates the distribution source image IM. The server selecting module 12 selects one spare server 300 from among the group of spare servers. The image distributing module 13 copies the first image IM1 to the spare server 300. These modules 11, 12 and 13 are provided through cooperation of software and an operation processing unit.

The spare server 300 has a copy determining module 31 and an image copying module 32. The copy determining module 31 determines whether or not it is required to copy data included in the second image IM2. The image copying module 32 controls a copying operation from the copy source storage 110 to the copy destination storage 310. These modules 31 and 32 are provided by cooperation of software included in the OS section 51 in the first image IM1 and the operation processing unit. The spare server 300 also stores copy source data 33 notified by the management server 100. The copy source data 33 specifies a network address of the management server 100 and the copy source storage 110. The copy source data 33 is stored in a storage device such as an RAM of the spare server 300.

Next, an operation of the server system 1 according to the present invention will be described with reference to FIGS. 3 and 9.

### Step S1;

First, the image creating module 11 creates the distribution source image IM of the storage 210 of the distribution server 200, and stores the distribution source image IM in the copy source storage 110. For example, a case is considered where a file on the disk 210 of the distribution server 200 is managed in the format as shown in FIG. 8. In this case, the image creating module 11 accesses the disk 210 of the distribution server 200 to read a portion equivalent to the first image IM1 and a portion equivalent to the second image IM2 without making any changes. Subsequently, the image creating module 11 stores a replica of the meta data 52 such as the i-list 63 included in the portion equivalent to the first image IM1 in the copy source storage 110. Thereafter, the image creating module 11 clears data in the address table 65 of the entire i-nodes 62 corresponding to a data block which belongs to the second image IM2. After these processes, the image creating module 11 stores the respective portions as the first image IM1 and the second image IM2 in the copy source storage 110.

Meanwhile, a case is considered where the disk 210 of the distribution server 200 is managed in the format shown in FIG. 6. In this case, the image creating module 11 initially reads entire data stored in the disk 210 of the distribution server 200. The image creating module 11 then replaces file locations so that the i-list 63 and the dispersed directory block 61 are located to be collected as shown in FIG. 8. At this time, data in the address table 65 of the entire i-nodes 62 are also replaced. Subsequent processes remain the same. That is, the image creating module 11 stores a replica of the meta data 52 in the copy source storage 110. Furthermore, the image creating module 11 clears data in the address table 65 of the entire i-nodes 62 corresponding to a data block which belongs to the second image IM2, out of the i-nodes 62 included in the portion equivalent to the first image IM1. These processes allow preparation of the first image IM1 and the second image IM2 in the format as shown in FIG. 8. The first image IM1 and the second image IM2 to be prepared are stored in the copy source storage 110.

### Steps S2 and S3:

Thereafter, a user or a load monitoring software requests the management server 100 to allocate an additional server. In response to the request, the server selecting module 12 selects one spare server 300 from the group of registered spare servers.

### Step S4:

Next, the first image IM1 is copied from the copy source storage 110 to the copy destination storage 310 (first stage copy). For example, in case of an SAN environment and in case of sharing the copy destination storage 310, the image distributing module 13 reads the first image IM1 from the copy source storage 110, and the first image IM1 is directly copied to the copy destination storage 310. Alternatively, the image distributing module 13 may also instruct the copy source storage 110 to realize a copy by a function on the storage side.

### Step S5:

Next, the management server 100 starts the spare server 300 by utilizing a WOL (wake-on LAN) function. As described above, the first image IM1 includes the OS section 51, thereby it is possible to start the server. At this time, the spare server 300, i.e. the additional server, starts a task. The copy determining module 31 and the image copying module 32 are also provided for the spare server 300 by cooperation of the software included in the OS section 51 and the operation processing unit. Furthermore, the management server 100 notifies the spare server 300 of the copy source data 33. The copy source data 33 is stored by an RAM in the spare server 300.

### Step S6:

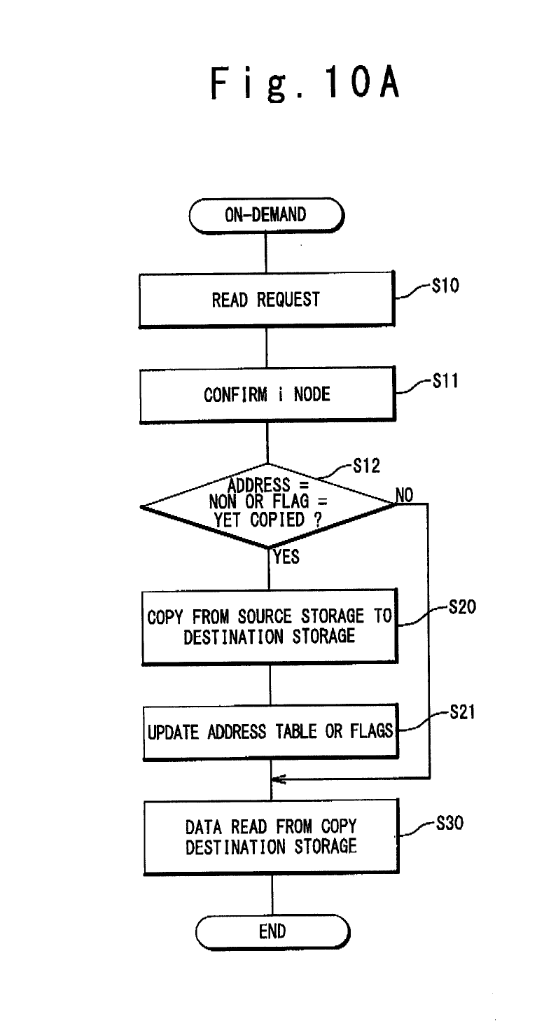

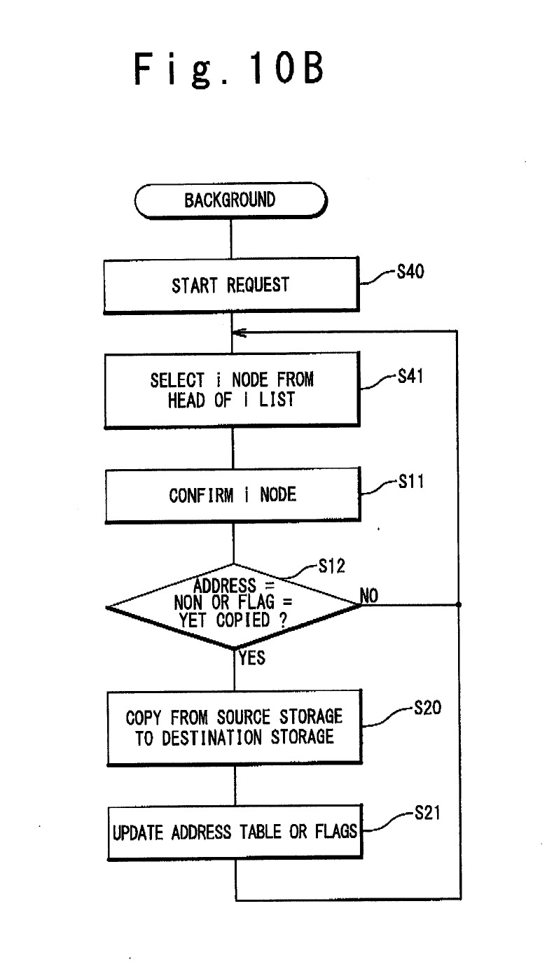

Thereafter, the second image IM2 is copied from the copy source storage 110 to the copy destination storage 310 during a task being executed by the additional server (second stage copy). The second image IM2 is copied in an on-demand and/or a background. FIGS. 10A and 10B are flowcharts showing details of a process in step S6 according to the present exemplary embodiment.

### Step S10:

In case of an on-demand copy as shown in FIG. 10A, access (read request) to the copy destination storage 310 is initially generated by a program in the operation state. At this time, a background copy to be described below is temporarily suspended.

### Step S11:

The copy determining module 31 of the spare server 300 determines whether or not an entity of object data as an access object exists in the copy destination storage 310. In the first exemplary embodiment, the copy determining module 31 refers to the meta data 52 included in the first image IM1, so that the determination is made on the basis of the meta data 52. Specifically, the copy determining module 31 checks data included in the i-node 62 (refer to FIG. 7) corresponding to the object data. On the basis of whether or not the address table 65 of the i-node 62 is empty, it can be determined whether or not a file entity exists.

### Step S12:

If the address table 65 is indicated in the i-node 62 (step S12; No), the object data is already copied. Accordingly, the object data is read from the address specified on the copy destination storage 310 (step S30). Meanwhile, if the file size 64 is indicated in the i-node 62 without indication of the address table 65 (step S12; Yes), the object data is not yet copied. That is, it is understood that access to an uncopied region is generated. In this case, a control flow moves to step S20.

### Step S20:

The image copying module 32 controls a process of copying the object data from the copy source storage 110. The image copying module 32 can recognize network addresses of the management server 100 and the copy source storage 110 by referring to the copy source data 33. For example, the image copying module 32 notifies file names of the object data to the management server 100 in order to instruct a copy of the object data. The management server 100 reads the object data from the copy source storage 110 on the basis of the file names. The management server 100 can read the object data from the copy source storage 110 by referring to the replica of the meta data 52 prepared in the above-described step S1. Then the management server 100 stores the read object data in a corresponding address region on the copy destination storage 310. The management server 100 may also instruct the copy source storage 110 to realize a copy by use of a function on the storage side.

### Step S21;

The management server 100 accesses the i-node 62 related to object data on the copy destination storage 310 in order to store an address in which the object data is stored, in the address table 65. Alternatively, the management server 100 notifies the address to the image copying module 32. The image copying module 32 stores the address in the address table 65 of the i-node 62 related to the object data. The address table 65 corresponding to the copied data is thus renewed. Thereafter, the object data is read from the address specified on the copy destination storage 310 (step S30).

A background copy plays a role to complement the above-described on-demand copy. Since the second image IM2 includes a file which is not often accessed, there is a possibility of necessity of a long time to complete a copy of the entire distribution source image IM by simply applying the on-demand copy. If the background copy is used in combination, a period of time to copy the entire distribution source image IM can be reduced. The background copy can be similarly made by the copy determining module 31 and the image copying module 32 in the spare server 300.

### Step S40:

In case of the background copy shown in FIG. 10B, the OS of the spare server 300 issues a start request. For example, the OS monitors a system load, and instructs the copy determining module 31 to start the background copy in case of a light system load.

### Step S41:

The copy determining module 31 selects the i-node 62 from the head of the i-list 63 sequentially. Subsequent processes are similar to those of the on-demand copy. The copy determining module 31 confirms each i-node 62 (step S11). If the copy is already made (step S12; No), a control flow returns to step S41 to select the subsequent i-node 62. If the copy is not yet made (step S12; Yes), the above-described steps S20 and S21 are executed. When step S21 is completed, the control flow returns to step S41 to select the subsequent i-node 62. If the on-demand copy is generated or a system load becomes heavier, the OS suspends the background copy. It is thus made possible to copy the second image IM2 from the copy source storage 110 to the copy destination storage 310 during a task executed by the additional server,

### MODIFIED EXAMPLE

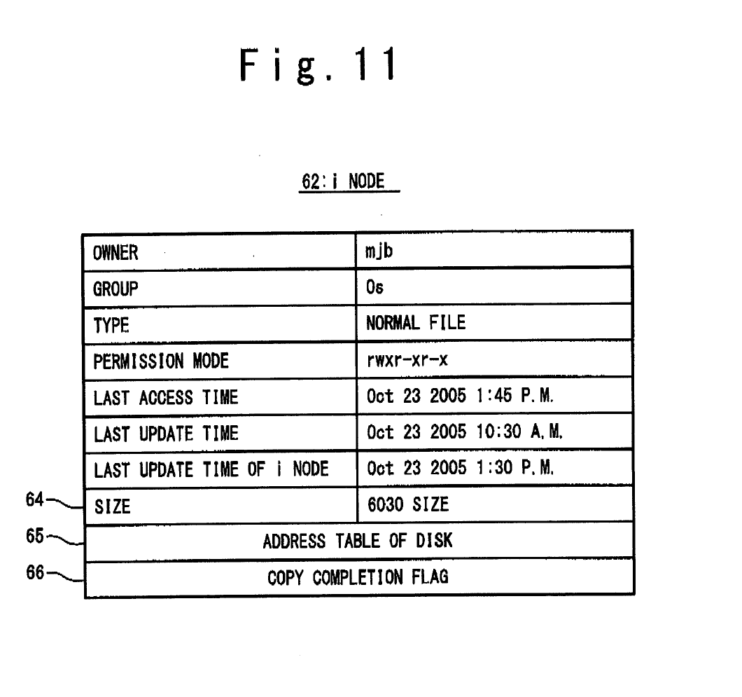

As shown in FIG. 11, a “copied flag 66” may also be newly added to the i-node 62 according to the present exemplary embodiment to indicate whether or not a copy was made. In this case, it is determined whether or not the object data was copied, by referring to the copied flag 66 of the i-node 62 in place of the address table 65 of the i-node 62. A unique process in a modified example will be described below.

At the step S1, the image creating module 11 creates the distribution source image IM of the disk 210 of the distribution server 200. For example, a case is considered in which a file on the disk 210 of the distribution server 200 is managed in a format as shown in FIG. 8. In this case, the image creating module 11 accesses the disk 210 of the distribution server 200 to read the portion equivalent to the first image IM1 and the portion equivalent to the second image IM2 without making any changes. Data in the address table 65 is not cleared. Next, the image creating module 11 adds the copied flag 66 to each of the i-nodes 62. In an initial state, the copied flags 66 of the entire i-nodes 62 corresponding to a data block which belongs to the first image IM1 are set to a “copied state”, while the copied flags 66 of the entire i-nodes 62 corresponding to a data block which belongs to the second image IM2 are set to an “uncopied state”. The image creating module 11 then stores the respective portions as the first image IM1 and the second image IM2 in the copy source storage 110.

Meanwhile, a case is considered where the disk 210 of the distribution server 200 is managed in a format shown in FIG. 6. In this case, the image creating module 11 initially reads entire data stored in the disk 210 of the distribution server 200. The image creating module 11 then replaces a file location so that the i-list 63 and the dispersed directory block 61 are located to be gathered as shown in FIG. 8. The image creating module 11 appropriately changes the address table 65 in each of the i-nodes 62 so as to reflect the replacement. The image creating module 11 further adds the copied flag 66 to each of the i-nodes 62. In an initial state, the copied flags 66 of the entire i-nodes 62 corresponding to data blocks which belong to the first image IM1 are set to the “copied state”, while the copied flags 66 of the entire i-nodes 62 corresponding to data blocks which belong to the second image IMS2 are set to the “uncopied state”. The first image IM1 and the second image IM2 to be created in a format as shown in FIG. 8 are stored in the copy source storage 110.

In the modified example, the second image IM2 is copied (step S6) as follows (refer to FIGS. 10A and 10B).

### Step S11:

The copy determining module 31 of the spare server 300 determines whether or not an entity of object data which is an object to access exists in the copy destination storage 310. In this modified example, the copy determining module 31 refers to the meta data 52 included in the first image IM1 in order to examine the copied flag 66 included in the i-node 62 (refer to FIG. 11) corresponding to the object data. It can be determined whether or not an entity of a file exists on the basis a “copied state” or an “uncopied state” of the copied flag 66.

### Step S12:

If the copied flag 66 indicates the “copied state” (step S12; No), the object data is already copied. Accordingly, object data is read from an address specified on the copy destination storage 310 (step S30). Meanwhile, if the copied flag 66 indicates the “uncopied state” (step S12; Yes), the object data is not yet copied. In this case, a process moves on to step S20.

### Step S20:

The image copying module 32 controls a process of copying the object data from the copy source storage 110. The image copying module 32 here can recognize a network address of the management server 100 and the copy source storage 110 by referring to the copy source data 33. The image copying module 32 is further capable of recognizing an address in which the object data exists by referring to the address table 65 in the i-node 62 related to the object data. Various kinds of copy subjects can be considered.

For example, in case of an SAN environment (refer to FIG. 2B) and in case of sharing the copy source storage 110, the spare server 300 is directly accessible to the copy source storage 110. In this case, the image copying module 32 directly accesses the copy source storage 110 by utilizing a file name and an address indicated in the address table 65. The image copying module 32 then reads the object data from the second image IM2 and the read object data is written into the copy destination storage 310.

Alternatively, the image copying module 32 may also instruct the management server 100 to copy the object data. At this time, the image copying module 32 notifies a file name to the management server 100. The management server 100 can read the object data from the copy source storage 110 on the basis of the received file name. The management server 100 then stores the read object data in a corresponding address on the copy destination storage 310. The management server 100 may also instruct the copy source storage 110 to realize a copy by a function on the storage side.

Alternatively, in case of an iSCSI environment, the image copying module 32 may instruct an iSCSI initiator (not shown) to issue an iSCSI command. At this time, the iSCSI command includes the file name and the address indicated in the address table 65. An issued iSCSI command is directly sent to the copy source storage 110. In response to the iSCSI command, the object data is read from the copy source storage 110, and the object data is sent to the copy destination storage 310.

### Step S21:

The image copying module 32 changes the copied flag 66 of the i-node 62 related to object data from an “uncopied state” to a “copied state”. The address table 65 corresponding to the copied data is thus renewed. Thereafter, the object data is read from an address specified on the copy destination storage 310 (step S30).

The processes in the remaining steps are the same. Thus, it becomes possible to copy the second image IM2 from the copy source storage 110 to the copy destination storage 310 during a task executed by the additional server.

### Second Exemplary Embodiment

Next the server system according to a second exemplary embodiment of the present invention will be described below. In the second exemplary embodiment, the same reference numerals or symbols are assigned to the same components as in the first exemplary embodiment, and the description thereof will be appropriately omitted.

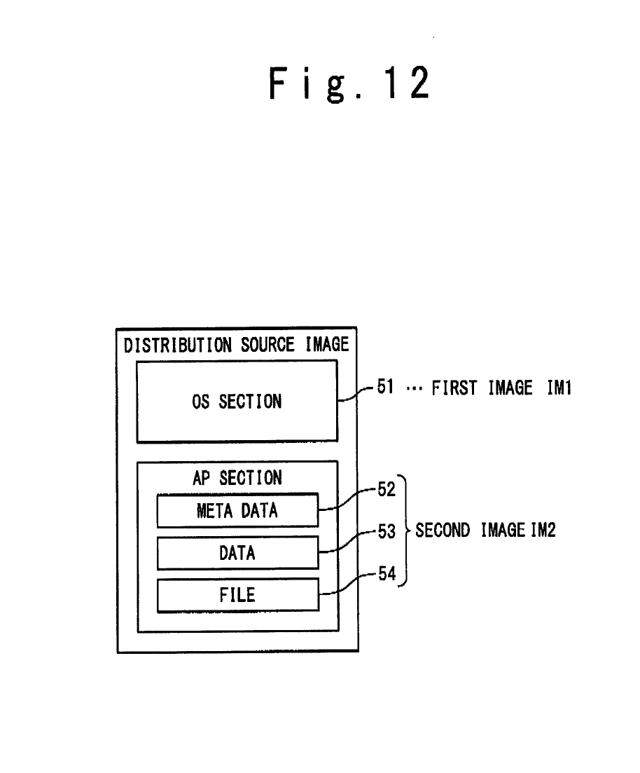

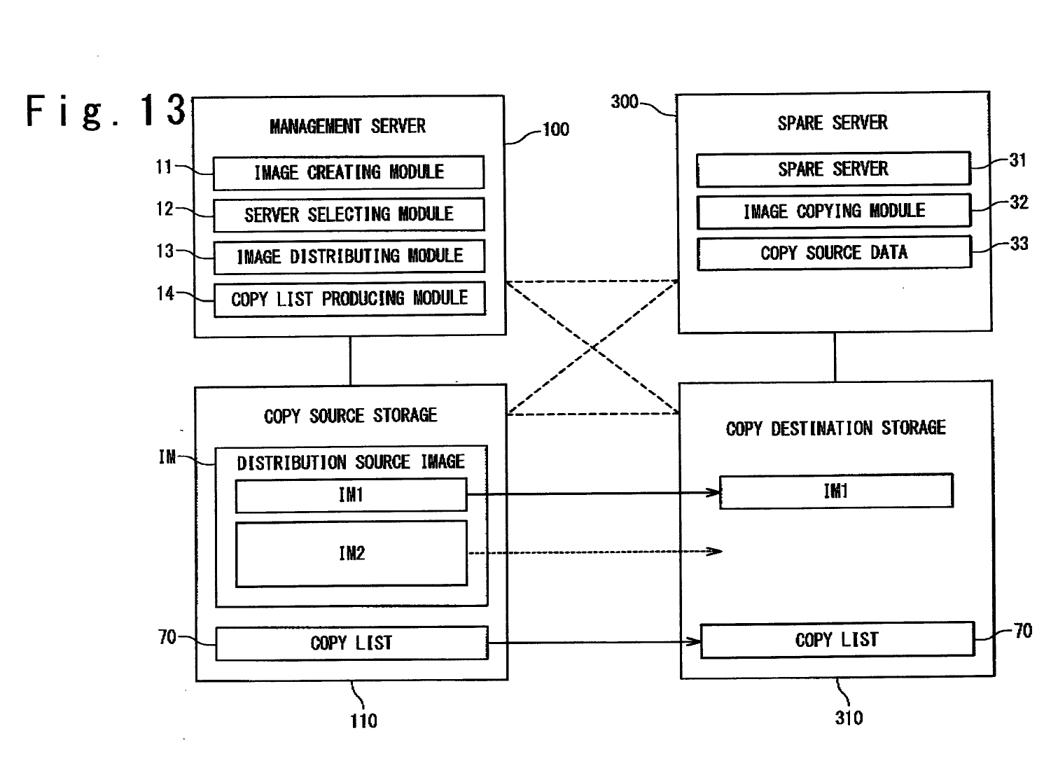

FIG. 12 is a conceptual diagram showing a classification of the distribution source image IM according to the second exemplary embodiment. In the present exemplary embodiment, the first image IM1 includes only the OS section 51 without including the meta data 52. The second image IM2 includes data except for the first image IM1.

FIG. 13 shows a configuration of the server system 1 according to the second exemplary embodiment. In FIG. 13, the management server 100, the spare server 300, the copy source storage 110, and the copy destination storage 310 are extracted and shown in particular. The management server 100 further has a copy list producing module 14. The copy list producing module 14 produces a copy list 70 which is a list of files included in the second image IM2.

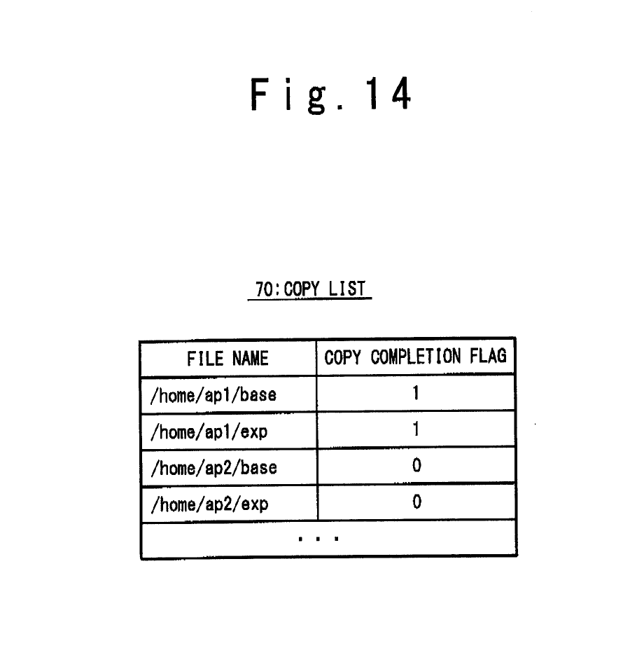

FIG. 14 shows an example of the copy list 70. The copy list 70 has a list of files included in the second image IM2, and copied flags indicating whether or not a copy was made. One file corresponds to one copied flag. For example, “0” of the copied flag indicates that the file is not yet copied into the copy destination storage 310. Moreover, as shown in FIG. 14, a file name is described in a full path. That is, it can be said that the copy list 70 includes address data of each file.

An operation example of the server system 1 according to the second exemplary embodiment will be described referring to already used in FIGS. 3 and 13.
Step S1:

First, the image creating module 11 accesses the storage 210 of the distribution server 200 to read the portion equivalent to the first image IM1 and the portion equivalent to the second image IM2 (refer to FIG. 12) without making any changes. The image creating module 11 then stores the respective portions to be read as the first image IM1 and the second image IM2 in the copy source storage 110 (step S1). The copy list producing module 14 also refers to the second image IM2 in the distribution source image IM to produce the copy list 70. In the produced copy list 70, entire copied flags are set to “0”. The produced copy list 70 is stored in the copy source storage 110.

### Steps S2 to S5:

Thereafter, in response to a request to allocate the additional server (step S2), the server selecting module 12 selects the spare server 300 (step S3). Subsequently, the first image IM1 is copied from the copy source storage 110 to the copy destination storage 310 (step S4). Simultaneously, the image distributing module 13 copies the above-described copy list 70 to the copy destination storage 310. Subsequently, the management server 100 starts the spare server 300 (step S5). At this time, the spare server 300, i.e. the additional server, starts a task.

### Step S6:

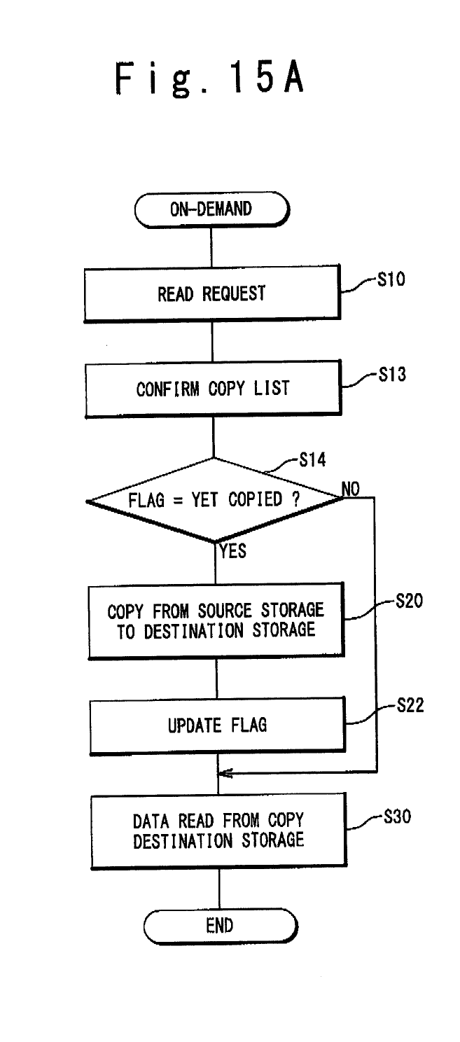

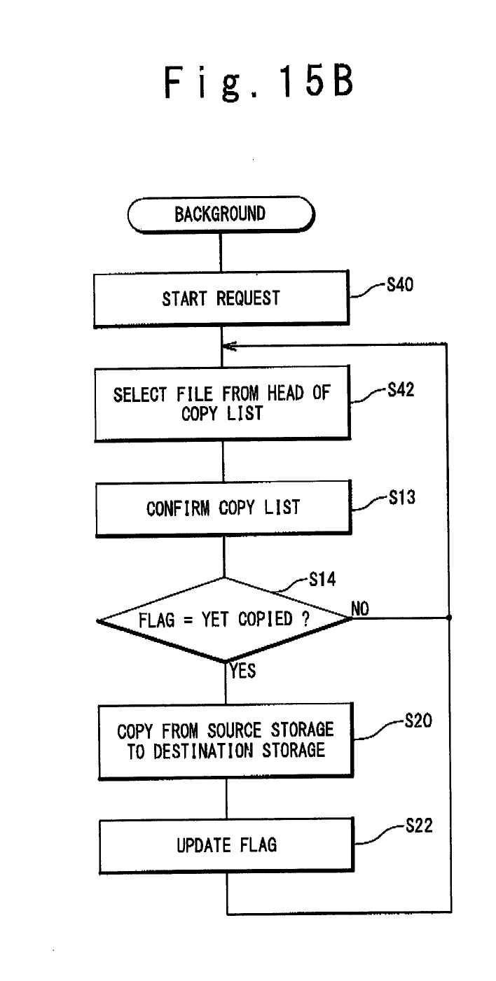

Thereafter, the second image IM2 is copied from the copy source storage 110 to the copy destination storage 310 during a task executed by the additional server. The second image IM2 is copied in an on-demand and/or background. FIGS. 15A and 15B are flowcharts showing details of a process at the step S6 according to the second exemplary embodiment.

### Step S11:

An on-demand copy shown in FIG. 15A is performed in the substantially same manner as the first exemplary embodiment. First, an access (read request) to the copy destination storage 310 is generated by a program in the operation state. At this time, a background copy to be described below is temporarily suspended.

### Step S13:

The copy determining module 31 of the spare server 300 determines whether or not an entity of the object data as an access object exists in the copy destination storage 310. In the second exemplary embodiment, the meta data 52 does not exist. Instead, the copy determining module 31 refers to the copy list 70 stored in the copy destination storage 310, so that determination is made on the basis of the copy list 70. Specifically, the copy determining module 31 examines whether the object data is included in the copy list 70. If the object data is included, the copy determining module 31 checks the copied flag corresponding to the object data (refer to FIG. 14).

### Step S14;

If the copied flag is “1” or in a copied state (step S14; No), the object data is read from an address specified on the copy destination storage 310 (step S30). Meanwhile, if the copied flag is “0” or in an uncopied state (Step S14; Yes), the control flow moves to step S20.

### Step S20:

The image copying module 32 controls a process of copying the object data from the copy source storage 110. The image copying module 32 here can refer to a network address of the copy source storage 110 indicated in the copy source data 33, and address data of a file indicated in the copy list 70. Details of the process are similar to those of the first exemplary embodiment.

### Step S22;

When the object data is copied into the copy destination storage 310, the image copying module 32 changes a copied flag corresponding to the object data from “0” to “1”. The remaining processes are the same with those of the first exemplary embodiment.

A background copy shown in FIG. 15B is also performed in the same manner as the first exemplary embodiment. First, the background copy is requested (step S40). The copy determining module 31 selects files from the head of the copy list 70 sequentially (step S42). The copy determining module 31 checks the copied flag corresponding to the file selected in the copy list 70 (step S13). If a copy is already made (step S14; No), the control flow returns to step S42 to select a subsequent file. If the copy is not yet made (step S14; Yes), the above-described steps S20 and S21 are executed. When step S22 is completed, the control flow returns to step S42 to select a subsequent file.

Thus it becomes possible to copy the second image IM2 from the copy source storage 110 to the copy destination storage 310 during a task executed by an additional server.

Next, the server system according to a third exemplary embodiment of the present invention will be described. In the third exemplary embodiment, the same reference numerals and symbols are assigned to the same components as in the first and second exemplary embodiments, and the description of thereof will be appropriately omitted. The third exemplary embodiment can also be combined with the first exemplary embodiment or the second exemplary embodiment as described above.

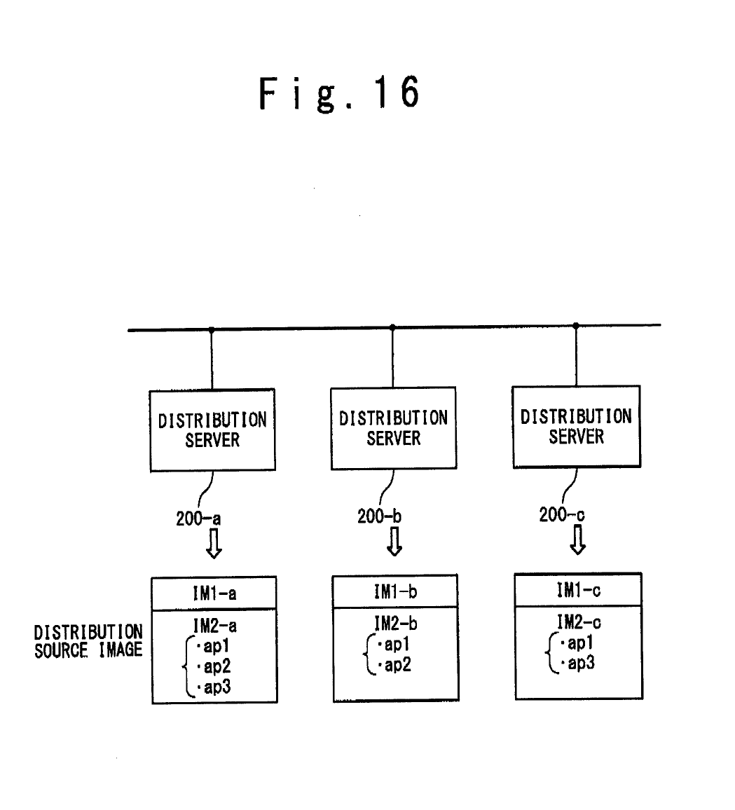

If a plurality of servers are in the operation state, there are a plurality of distribution source images which can be distributed. For example, three servers (distribution server) 200-a, 200-b, and 200-c are in the operation state in FIG. 16. A distribution source image of the distribution server 200-a is composed of a first image IM1-a and a second image IM2-a. The second image IM2-a includes application data ap1, ap2 and ap3. Similarly, a distribution source image of the distribution server 200-b is composed of a first image IM1-b and a second image IM2-b, and the second image IM2-b includes application data ap1 and ap2. A distribution source image of the distribution server 200-c is composed of a first image IM1-c and a second image IM2-c, and the second image IM2-c includes application data ap1 and ap3. In an example shown in FIG. 16, the second images IM2-a to IM2-c have duplicated data. Accordingly, each of the second images IM2 is divided and the application data ap1, ap2 and ap3 are separately stored, so that a disk space can be saved. When the second image IM2 is copied, necessary application data should be appropriately copied. At this time, the application data ap1, ap2 and ap3 may also be stored in copy source storages that are different from each other. That is, the second distribution source image IM2 may be divided into a plurality of division images so as to store the plurality of the division images in a plurality of copy source storages distributedly.

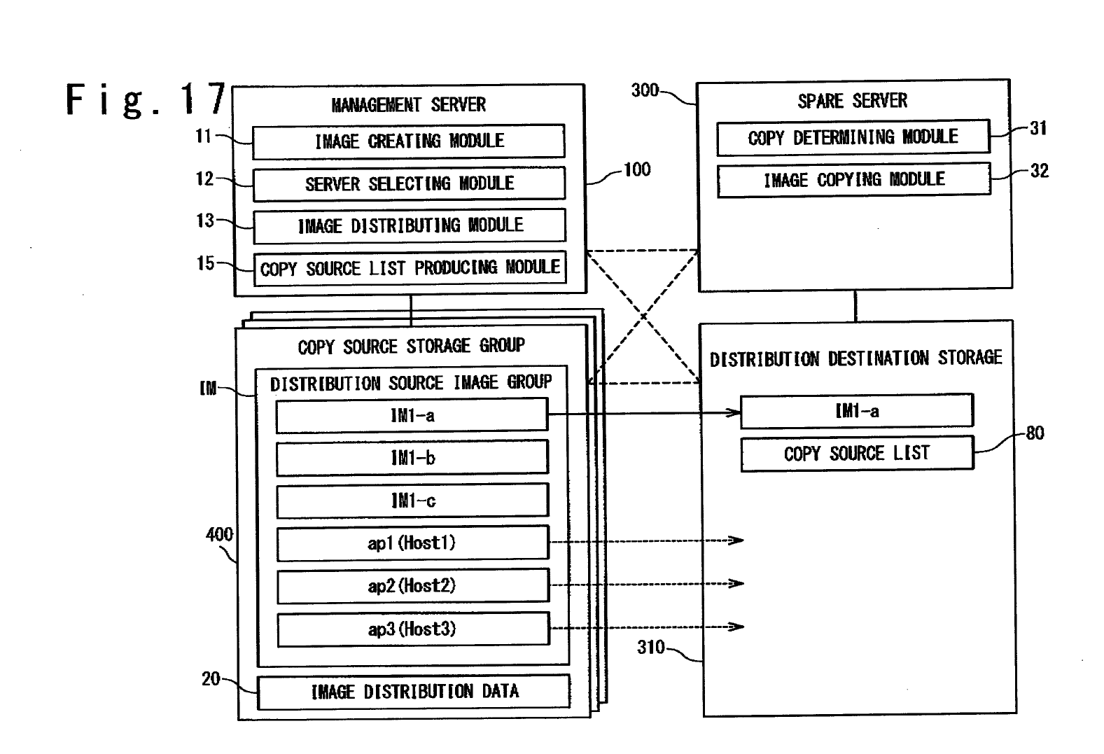

FIG. 17 shows a configuration of the server system 1 according to the third exemplary embodiment. In FIG. 17, the management server 100, the spare server 300, the copy destination storage 310, and a group of the copy source storages 400 are extracted and shown in particular. In the group of the copy source storages 400, the distribution source image IM, i.e. a plurality of division images are stored distributedly. The management server 100 has a copy source list producing module 15.

An operation example of the server system 1 according to the third exemplary embodiment will be described referring to already used FIGS. 3 and 17.

### Step S1:

First, the image creating module 11 produces the distribution source image in the same manner as the first and second exemplary embodiments as described above. Subsequently, the image creating module 11 divides the second distribution source image IM2 into a plurality of division images, and the plurality of the division images are distributedly stored in the group of the copy source storages 400. The image creating module 11 further creates image distribution data 20 to indicate a distributed state of the division images.

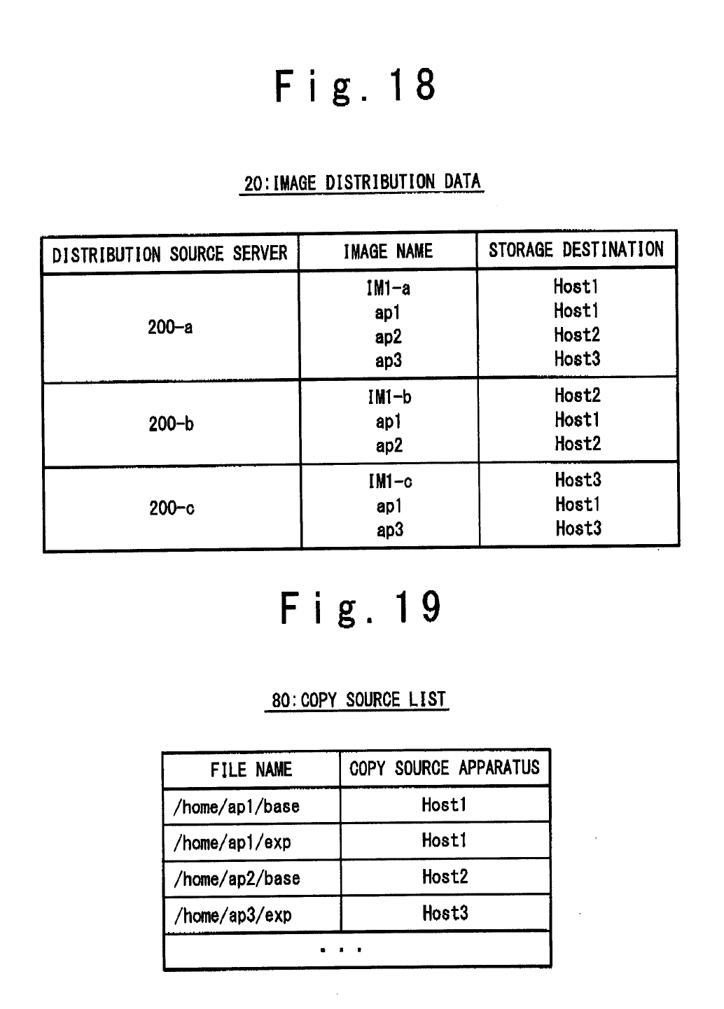

FIG. 18 shows an example of the image distribution data 20. The image distribution data 20 indicates the division image and the storage destination thereof with respect to each of the distribution servers 200. For example, the second image IM2 of the distribution server 200-a is divided into a plurality of division images ap1, ap2 and ap3, so that the plurality of division images ap1, ap2 and ap3 are stored in mutually different copy sources Host 1, Host2, and Host 3. It is the same in the remaining distribution servers 200-b and 200-c. The identical division image is stored in the identical copy source. The produced image distribution data 20 is stored in a predetermined storage.

### Steps S2 and S3:

Next, the management server 100 is requested to allocate an additional server. For example, it is assumed that the distribution source image IM of the distribution server 200-a is distributed to the spare server 300.

### Step S4:

The image distributing module 13 recognizes a storage destination of the first image IM1-a by referring to the image distribution data 20 shown in FIG. 18. The image distributing module 13 then copies the first image IM1-a from the copy source (Host 1) to the copy destination storage 310. The copy source list producing module 15 further produces a copy source list 80 by referring to the image distribution data 20, and the copy source list 80 is copied into the copy destination storage 310. The copy source list 80 indicates a location where the second image IM2-a is stored, i.e. a location where each of the division images (ap1, ap2 and ap3) is stored.

FIG. 19 shows an example of the copy source list 80. The copy source list 80 indicates a location (copy source device) where each file included in the second image IM2-a is stored. It is understood that a file included in each of the division images ap1, ap2 and ap3 is stored in the different copy sources Host 1, Host 2, and Host 3. The copy source list 80 is produced so that these division images ap1, ap2 and ap3 become the objects to copy.

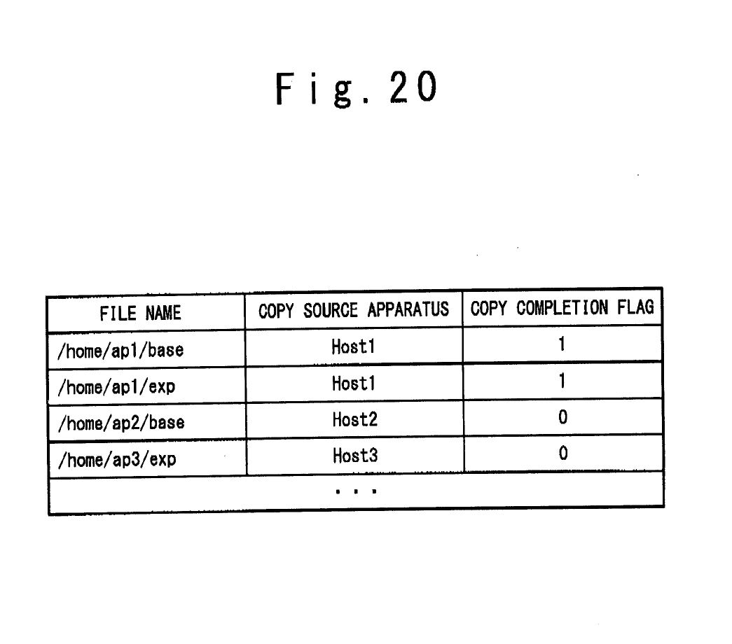

If the third exemplary embodiment is applied to the second exemplary embodiment, the copy list 70 shown in FIG. 14 and the copy source list 80 shown in FIG. 19 may be combined. In this case, the copy source list producing module 15 produces the copy source list 80 as shown in FIG. 20. In FIG. 20, the copy source list 80 indicates a list of files included in the second image IM2-a, copy source devices, and copied flags. One file corresponds to one copied flag. This copy source list 80 is also used as the copy list 70.

### Step S5:

Next, the management server 100 starts the spare server 300. At this time, the spare server 300, i.e. the additional server, starts a task.

### Step S6:

Thereafter, the second image IM2-a is copied from the group of the copy source storages 400 to the copy destination storage 310 during a task executed by the additional server. In step S20 shown in FIGS. 10A, 103, 15A and 15B, a copy source of the object data is specified by referring to the above-described copy source list (FIG. 19 or 20). The difference from the above-described exemplary embodiments is to have various copy sources, and a copy process itself remains the same.

Thus, it becomes possible to copy the second image IM2 from the copy source storage 110 to the copy destination storage 310 during the task executed by the additional server. According to the present exemplary embodiment, an effect similar to that of the above-described exemplary embodiments can be obtained. Furthermore, the distribution source image IM is divided and same division images are shared, so that a disk space can be effectively utilized.

Although the present invention has been described above in connection with exemplary embodiments thereof, it will be apparent to those skilled in the art that those embodiments are provided solely for illustrating the present invention, and should not be relied upon to construe the appended claims in a limiting sense.

What is claimed is:

1. A disk image distributing method comprising:
copying a first image containing a program necessary to start a computer, as a part of a disk image to a storage unit of a predetermined computer;
starting said predetermined computer based on said program; and
copying a second image as a remaining part of said disk image into said storage unit of said predetermined computer after the start of said predetermined computer.

2. The disk image distributing method according to claim 1, wherein said predetermined computer is a spare computer to be added to a current operation system, and
said disk image is of a computer in the current operation system.

3. The disk image distributing method according to claim 1, wherein said copying a second image comprises:
copying said second image in a background of an operation of said predetermined computer.

4. The disk image distributing method according to claim 1, wherein said copying a second image comprises:
copying said second image in an on-demand method in response to an access to said storage unit of said predetermined computer.

5. The disk image distributing method according to claim 1, wherein said second image has been stored in a specified copy source, and
said copying a second image comprises:
determining whether or not an entity of target data as access target exists, when said predetermined computer accesses said storage unit; and
copying said target data of said second image from a specified copy source to said storage unit when the entity of said target data does not exist.

6. The disk image distributing method according to claim 1, wherein said second image comprises a plurality of divisional images which are dispersedly stored in a plurality of copy sources, and
said copying a second image comprises:
determining whether or not an entity of target data as access target exists, when said predetermined computer accesses said storage unit; and
copying said target data of said second image from a copy source specified from among said plurality of copy sources to said storage unit when the entity of said target data does not exist.

7. The disk image distributing method according to claim 6, further comprising:
producing a copy source list to indicate which of said plurality of copy sources each of said plurality of divisional images is stored in; and
storing said copy source list in said storage unit of said predetermined computer,
wherein said copying said target data of said second image comprises;
specifying said specified copy source by referring to said copy source list.

8. The disk image distributing method according to claim 5, wherein said first image further contains a meta data as a management data of files, and
said determining comprises:
carrying out the determination based on said meta data.

9. The disk image distributing method according to claim 8, wherein said meta data contains an i-node, and
said determining comprises:
carrying out the determination based on whether an address is shown in said i-node corresponding to said target data.

10. The disk image distributing method according to claim 5, further comprising;
producing a copy list indicating a list of files contained in said second image and a copy data of whether each of the files was already copied; and
storing said copy list in said storage unit of said predetermined computer,
wherein said determining comprises:
carrying out the determination based on said copy list, and
said copying said target data comprises:
changing said copy data corresponding to said target data into a data indicating an already copied state.

11. A computer system comprising:
a management computer; and
a computer connected with said management computer through a network,
wherein said management computer copies a first image which is a part of a predetermined disk image and which contains a program necessary to start said computer into a storage unit of said computer, and
said computer copies a second image which is a remaining part of said predetermined disk image into said storage unit, after being started based on said program.

12. The computer system according to claim 11, wherein said management computer notifies a copy source where said second image has been stored to said computer, and
said computer comprises:
a copy determining module configured to determine whether an entity of target data as an access target exists, when accessing said storage unit; and
a copying module configured to control a copy of said target data from the notified copy source to said storage unit when the entity of said target data does not exist.

13. The computer system according to claim 11, further comprising:
an operation-mode computer,
wherein said disk image is a disk image of said operation-mode computer.

14. A computer system comprising:
a copy determining module configured to determine whether an entity of a target data as an access target exists when a storage unit is accessed; and
a copying module configured to control a copy of said target data from a specified copy source to said storage unit when a substance of said target data does not exist.

15. The computer system according to claim 14, wherein a first image which is a part of a disk image and which contains a program necessary to start a computer is stored in said storage unit, and
a second image which is a remaining part of said disk image is stored in said specified copy source.

16. The computer system according to claim 14, wherein a first image which is a part of a disk image and which contains a program necessary to start a computer is stored in said storage unit, and
a second image which is a remaining part of said disk image is composed of a plurality of divisional images which are dispersedly stored in a plurality of copy sources.

17. The computer system according to claim 16, wherein a copy source list is stored in said storage unit to indicate which of said plurality of copy sources each of said plurality of divisional images is stored in, and
said copying module specifies one of said plurality of copy sources by referring to said copy source list.

18. The computer system according to claim 15, wherein said first image further contains a meta data as a management data of files, and
said copy determining module carry out the determination by referring to said meta data.

19. The computer system according to claim 18, wherein said meta data contains an i-node,
said copy determining module carries out a said judgment based on whether an address is shown in said i-node corresponding to said target data.

20. The computer system according to claim 15, wherein a copy list is stored in said storage unit to indicate a list of files contained in said second image and a copy data of whether each of the files has been already copied,
said copy determining module refers to said copy list to carry out the determination and changes the copy data corresponding to said target data into an already copied state after the copy of said target data completes.

21. The computer system according to claim 15, wherein said copying module reads said target data from a specified copy source and writes the read target data in said storage unit.

22. The computer system according to claim 15, wherein said copying module instructs the specified copy source to copy said target data.

23. A management computer comprising:
an image distributing module configured to copy a first image which is a part of a predetermined disk image into a computer connected through a network,
wherein said first image contains a program necessary to start said computer and a module configured to control a copy of a second image which is a remaining part of said predetermined disk image.

24. The management computer according to claim 23, wherein said first image contains a meta data as a management data of files in said disk image.

25. The management computer according to claim 23, further comprising:
a copy list producing module configured to produce a copy list which has a list of the files contained in said second image and a copy data of whether each of the files is in an already copied state,
wherein said image distributing module sends said copy list to said computer together with said first image.
